(19) United States
(12) Patent Application Publication
(10) Pub. No.: US 2009/0096776 A1
(43) Pub. Date: Apr. 16, 2009

(54) Device for controlling output of light source unit in single panel display system

(75) Inventors: Kyu Bum Han, Yongin-si (KR); Seung Woo Lee, Suwon (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd., Suwon (KR)

(21) Appl. No.: 12/080,678

(22) Filed: Apr. 4, 2008

(30) Foreign Application Priority Data
Apr. 19, 2007 (KR) 10-2007-0038455

(51) Int. Cl. G09G 5/00; H04N 5/04

(52) U.S. Cl. 345/213; 348/500

(57) ABSTRACT

The present invention relates generally to a device for controlling the output of a light source unit in a single panel display system. More particularly, the present invention relates to a device for controlling the output of a light source unit in a single panel display system, which adjusts the time of application of light source driving voltage based on the output characteristics of each light source, and adjusts video data for the light source based on the adjusted time, thereby preventing a garbage image from being generated.

### CROSS REFERENCE TO RELATED APPLICATION

This application claims the benefit of Korean Patent Application No. 10-2007-0038455, filed on Apr. 19, 2007, entitled “Controller of the Light Source Output in the One Panel Display System,” which is hereby incorporated by reference in its entirety into this application.

### BACKGROUND OF THE INVENTION

1. Field of the Invention

The present invention relates generally to a device for controlling the output of a light source unit in a single panel display system and, more particularly, to a device for controlling the output of a light source unit in a single panel display system, which adjusts the time of application of light source driving voltage based on the output characteristics of each light source, and adjusts video data for the light source based on the adjusted time, thereby preventing a garbage image from being generated.

2. Description of the Related Art

With the development of micro technology, Micro-Electro-Mechanical System (MEMS: a super small-sized electrical and mechanical composite) devices, and small-sized apparatuses in which MEMS devices are included, are attracting attention.

An MEMS device is configured in the form of a microstructure on a substrate, such as a silicon substrate or a glass substrate, and is formed by electrically and mechanically combining an actuation unit for outputting a mechanical actuating force with a semiconductor integrated circuit for controlling the actuation unit.

Recently, Spatial Light Modulators (SLMs) using such MEMS devices have been developed.

Display devices using such SLMS have been well known. A prior art display device using a diffractive optical modulator includes a light source unit, a light condensing unit, an illumination unit, a diffractive light modulator, a filter unit, a projection unit, and a screen.

Here, the light source unit includes a plurality of light sources. In an application, the plurality of light sources may be configured to be sequentially turned on. The condensing unit causes beams of light emitted from the plurality of light sources to have a single light path by combining the beams of light with each other.

The illumination unit converts light, having passed through the light condensing unit, into linear parallel light, and causes the linear parallel light to enter the diffractive optical modulator. The diffractive optical modulator generates linear diffracted light having a plurality of diffraction orders by modulating the incident linear parallel light, and emits the linear diffracted light. Here, diffracted light having one or more desired diffraction orders may be configured such that the light intensity thereof varies at respective points of the light path thereof so as to form images on the screen. That is, since the diffracted light generated by the diffractive optical modulator is linear and the linear diffracted light may have light intensity varying at respective points, it can form a two-dimensional image on the screen 28 when it is scanned across the screen.

The diffracted light generated by the diffractive optical modulator enters the filter unit. The filter unit separates the diffracted light according to diffraction order, and passes only diffracted light having a desired diffraction order therethrough.

The projection lens magnifies incident diffracted light, and produces images by projecting the magnified incident diffracted light onto the screen.

Meanwhile, the above-described single panel display device using a single reflective light modulator sequentially turns on the plurality of light sources that constitute the light source unit.

In this case, semiconductor lasers are used as red and blue laser light sources, so that desired beams of light can be acquired at desired times because the response speed is high.

That is, as shown in FIG. 1A, since the red laser light source and the blue laser light source have rapid response speeds at the time at which input current is applied, light output immediately follows the input current, so that desired light can be acquired at a desired time.

As described above, rapid responses to input signals for the red laser light source and the blue laser light source can be acquired, so that uniform images can be acquired.

In contrast, a solid laser is used as a green laser light source, and it is difficult to acquire a desired response at a desired time because the response speed is slow.

That is, for the green laser light source, material capable of emitting light having a specific wavelength has not been discovered to date, unlike material for the red light and blue light. Accordingly, the green laser light source employs a structure for generating green light while reducing the output wavelength of material, emitting a wavelength (1064 nm) in a near infrared ray band to a half of the output wavelength (for example, 532 nm), so that it is difficult to acquire a desired response at a desired time because the speed of generation of light output is slow.

That is, as shown in FIG. 1B, the green laser light source is formed of a solid laser, and the response speed characteristics thereof are inferior to those of the red laser light source and the blue laser light source formed of semiconductor lasers due to the internal pumping mechanism of the light source.

### SUMMARY OF THE INVENTION

Accordingly, the present invention has been made keeping in mind the above problems occurring in the prior art, and an object of the present invention is to provide a device for controlling the output of a light source unit in a single panel display system, which adjusts the time of application of light source driving voltage based on the output characteristics of each light source and adjusts video data for the light source based on the adjusted time, thereby preventing a garbage image from being generated and acquiring desired light at a desired time.

In order to accomplish the above object, the present invention provides a device for controlling output of a light source unit in a single panel display system using a diffractive light modulator, including a video processing unit for receiving video data and synchronizing signals, performing data transposition, outputting red video data and blue video data in an effective video period, outputting green video data having gray level 0 in a blank period before the effective video period with respect to green video data, outputting the received video data in the effective video period, and outputting the received synchronizing signals; a light source driving unit for, when the synchronizing signals are input from the video processing unit, applying driving voltage to the red light source and the blue light source in the effective video period, and applying driving voltage to the green light source in the blank period before the effective video period, with respect to the green video data; and a light modulator driving circuit for applying driving voltage to the reflective light modulator based on the video data from the video processing unit.

In addition, in order to accomplish the above object, the present invention provides a device for controlling output of a light source unit in a single panel display system using a diffractive light modulator, including a video processing unit for receiving video data and synchronizing signals, performing data transposition, outputting data-transposed video data, and outputting the received synchronizing signals; a light source driving unit for, when the synchronizing signals are input from the video processing unit, applying driving voltage to the red light source and the blue light source in the effective video period, and applying excitation driving voltage to the green light source in a blank period before the effective video period and driving voltage to the green light source in the effective video period, with respect to the green video data; and a light modulator driving circuit for applying driving voltage to the reflective light modulator based on the video data from the video processing unit.

### BRIEF DESCRIPTION OF THE DRAWINGS

The patent or application file contains at least one drawing executed in color. Copies of this patent or patent application publication with a color drawing will be provided by the Office upon request and payment of the necessary fee.

The above and other objects, features and advantages of the present invention will be more clearly understood from the following detailed description taken in conjunction with the accompanying drawings, in which:

FIG. 1A is a diagram showing the light output characteristics of a blue laser light source or a red laser light source, and FIG. 1B is a diagram showing the light output characteristics of a green light source;

FIG. 2 is a diagram showing the construction of a display device using a reflective light modulator, which is applied to the present invention;

FIG. 3 is a diagram showing an example of a garbage image in the case where a green light source is turned on and a gray level is not adjusted in the display device of FIG. 2;

FIG. 4 is a diagram showing the light output characteristics of the green light source of FIG. 2;

FIG. 5 is a diagram showing the construction of a device for controlling the output of a light source unit according to a preferred embodiment of the present invention;

FIG. 6 is a flowchart showing a method of controlling the output of a light source unit according to a first preferred embodiment of the present invention;

FIG. 7 is a flowchart showing a method of controlling the output of a light source unit according to a second preferred embodiment of the present invention;

FIG. 8 is a diagram showing a signal waveform that is used in the first preferred embodiment of the present invention of FIG. 6; and

FIG. 9 is a diagram showing a signal waveform that is used in the second preferred embodiment of the present invention of FIG. 7.

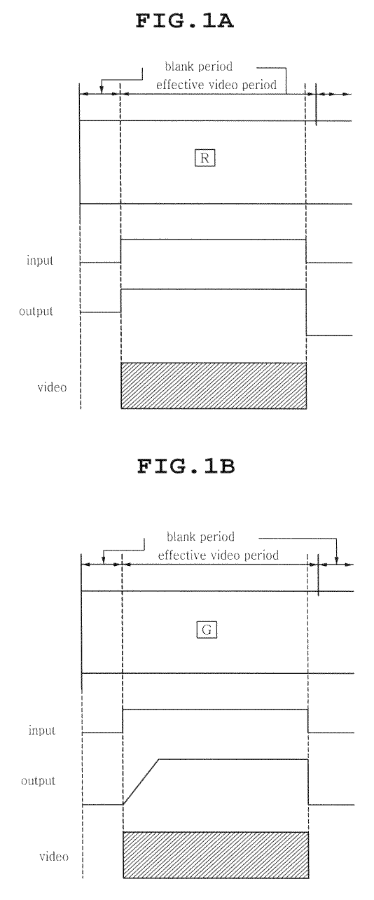

### DESCRIPTION OF THE PREFERRED EMBODIMENTS

Reference now should be made to the drawings, in which the same reference numerals are used throughout the different drawings to designate the same or similar components.

A device for controlling the output of a light source unit in a single panel display system according to a preferred embodiment of the present invention will be described in detail with reference to the accompanying drawings.

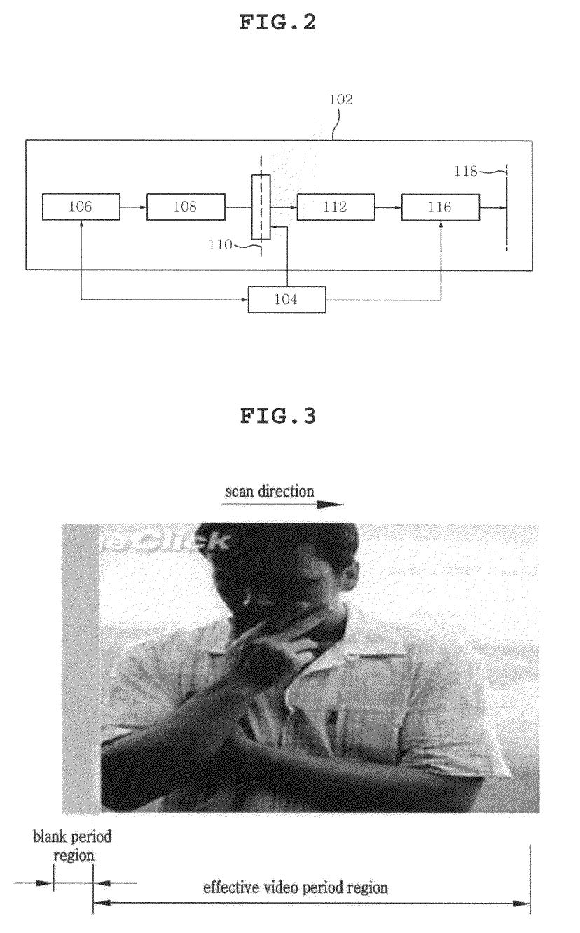

FIG. 2 is a diagram showing the construction of a display device using a reflective light modulator, which is applied to the present invention.

Referring to this drawing, the display device using a diffractive light modulator, to which the present invention is applied, includes display optics 102 and display electronics 104.

The display optics 102 include a light source unit 106 that generates light and emits the generated light. A light source, formed of a semiconductor, such as a Vertical External Cavity Surface Emitting Laser (VECSEL), a Vertical Cavity Surface Emitting Laser (VCSEL), a Light Emitting Diode (LED), a Laser Diode (LD) or a Super Luminescent Diode (SLED), maybe used as each light source of the light source unit 106.

The light source unit 106 emits laser light. The cross-section of the laser light is circular, and the intensity profile of the laser light has a Gaussian distribution. For example, the light source unit 106 (in practice, it is formed of an R laser, a G laser and a B laser) may be configured to sequentially emit R light, G light and B light.

The display optics 102 further include an illumination unit 108, which radiates light emitted from the light source unit 106 onto the diffractive optical modulator 110 in the form of linear parallel light.

The illumination unit 108 converts the laser light, emitted from the light source 106, into light having a long length and a narrow width, converts the linear light into parallel light, and causes the parallel light to enter the diffractive optical modulator 110.

The illumination unit 108 may be formed of, for example, a convex lens (not shown), or a combination of a convex lens (not shown) and a collimating lens (not shown).

The display optics 102 further include the diffractive optical modulator 110, which generates diffracted light having a plurality of diffraction orders by diffracting the linear light incident from the illumination unit 108.

In this case, the diffracted light, emitted by the diffractive optical modulator 110, may include beams of diffracted light having several diffraction orders, such as 0th-order diffracted light, ±1st-order diffracted light, ±2nd-order diffracted light and ±3rd-order diffracted light. The difference in phase between odd-numbered diffraction order light and even-numbered diffraction order light is 180°.

The diffracted light, emitted by the diffractive optical modulator 110, is linear diffracted light having a long length and a narrow width.

Here, the reflective light modulator 110 includes, for example, a plurality of upper reflective parts, which are configured to move vertically and form an array, and a plurality of lower reflective parts, which are disposed between the upper reflective parts and are spaced apart from the upper reflective parts by a predetermined distance. The reflective light modulator 110 may employ electrostatic force or magnetostatic force as means for driving the upper reflective parts, and may use a piezoelectric material layer, on one surface of which an upper electrode layer is formed and on the other surface of which a lower electrode layer is formed.

With regard to the diffracted light emitted by the diffractive optical modulator 410, diffracted light, which is formed by one upper reflective part and a corresponding lower reflective part, may form diffracted light corresponding to one pixel of an image formed on the screen 118, or diffracted light, which is formed by two or more upper reflective parts and corresponding lower reflective parts, may form diffracted light corresponding to one pixel of an image formed on the screen 118.

The display optics 102 further include a projection unit 112, which directs the diffracted light having a plurality of diffraction orders, emitted from the diffractive optical modulator 110, toward the screen 118 and scans the diffracted light across the screen 118.

Here, the projection unit 112 maintains the linear velocity of an image, which is displayed on the screen 118 under the control of the display electronics 104, at a constant velocity when performing scanning on the screen 118.

An example of the projection unit 112 includes a projection lens (not shown) and a scanner (not shown) for scanning diffracted light across the screen 118.

The projection lens is formed of a combination of a plurality of convex lenses and a plurality of concave lenses, and functions to condense incident light so that the diffracted light is focused on the screen 118.

The scanner may be a Galvanometer mirror scanner or a polygon mirror scanner. The Galvanometer scanner has a square plate shape, and is provided with a mirror on one surface of a square plate. The Galvanometer scanner rotates laterally within a predetermined angular range around an axis. The polygon mirror scanner has a polygonal column shape, and is provided with mirrors on the side surfaces of a polygonal column. The polygonal mirror scanner projects images onto the screen 118 by varying the reflection angle of incident light using the mirrors attached to the sides thereof while rotating in one direction around an axis.

The display optics 102 further include a filter unit 116, which is disposed between the projection unit 112 and the screen 118, and passes only diffracted light having one or more desired diffraction orders, which belongs to diffracted light having a plurality of diffraction orders, which is emitted by the projection unit 112, therethrough. An example of the filter unit 116 is a slit.

Meanwhile, the display electronics 104 are connected to the light source unit 106, the diffractive light modulator 110, and the projection unit 112. The display electronics 104 control the plurality of light sources so that beams of light are sequentially output from the plurality of light sources.

The display electronics 104 drive upper reflective parts by providing driving voltages to the upper and lower electrode layers of the piezoelectric layer of the diffractive optical modulator 110. Here, it should be noted that, in the case of a red light source and a blue light source, it is possible for the display electronics 104 to turn on the relevant light sources at desired time because the light sources are semiconductor light sources and have rapid response speeds, but, in the case of a green light source, it is necessary for the display electronics 104 to turn on the green light source in advance of a desired time in consideration of response time so as to acquire desired light at the desired time because the green light source is a solid laser light source and has a relatively slow response speed.

However, since light is emitted from the green light source before the desired time when this is done, a garbage image is created on the screen 118.

That is, since the time at which the green light source is turned on falls within a blank period, the light, generated in the green light source, is projected in the blank period regions, which fall outside a relevant effective video period region of the screen 118, so that a garbage image may be created. Referring to FIG. 3, although it is required to create a black image on the screen 118 during the blank period of FIG. 3, vague green light is generated. The reason for this is that, in the case where a certain gray level value is applied to the reflective light modulator 110 when the green light source is turned on, diffracted light based on the gray level value is generated and projected onto the screen 118.

To solve this problem, the display electronics 104 sets driving voltage, to be provided to the reflective light modulator 110, to 0 until desired time is reached, and outputs the driving voltage. By doing so, the green light source is turned on before the desired time, but the reflective light modulator 110 does not generate video data for a relevant light source, so that a garbage image is not created.

Of course, in another embodiment, the display electronics 104 apply a voltage that is lower than a critical voltage for emitting light to the green light source in advance so as to turn on the green light source at a desired time, thereby exciting the green light source, and so as to apply a voltage higher than the critical value thereto, thereby fully activating the green light source.

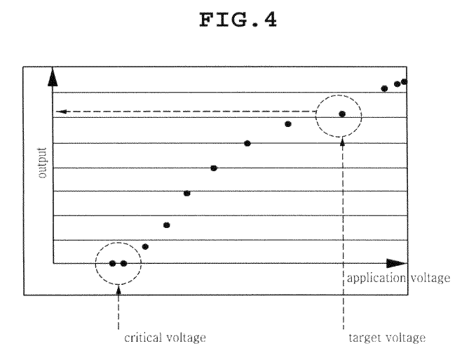

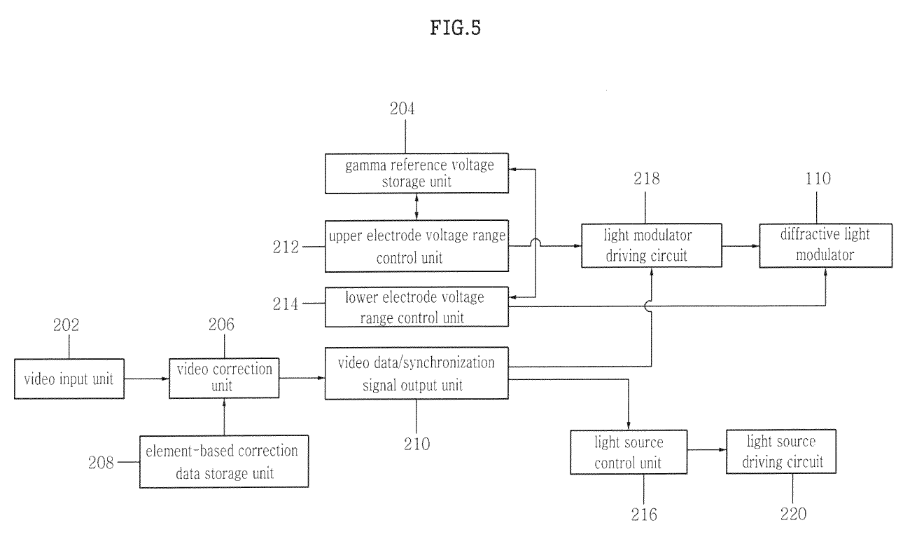

That is, the display electronics 104 primarily apply voltage for the green light source at a level appropriately lower than a critical voltage in a blank period and secondarily increase the application voltage to a target value in an effective video period. By doing so, the green light source does not emit light during the blank period. The reason for this is that the green light source does not generate light output at voltages lower than the critical voltage. Referring to FIG. 4, a voltage lower than the critical voltage is applied in a blank period. Then, as shown in FIG. 4, the green light source does not generate light output, so that a garbage image is not created. Thereafter, when a voltage higher than the critical value is applied in an effective video period, the green light source starts to generate light output, so that an effective image is projected onto the screen 118.

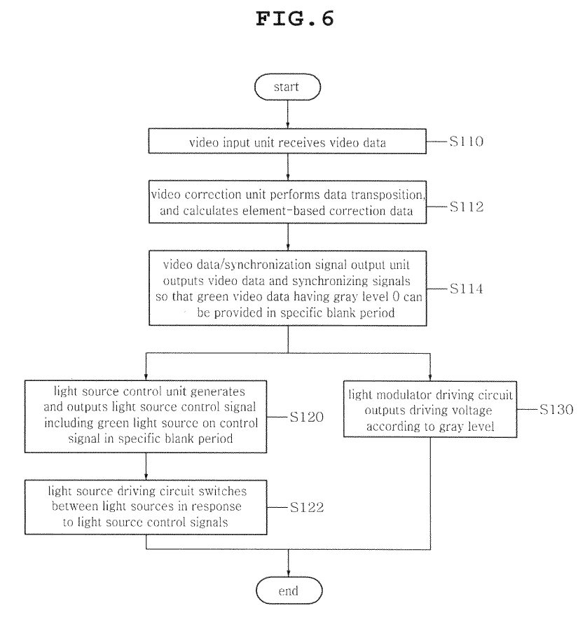

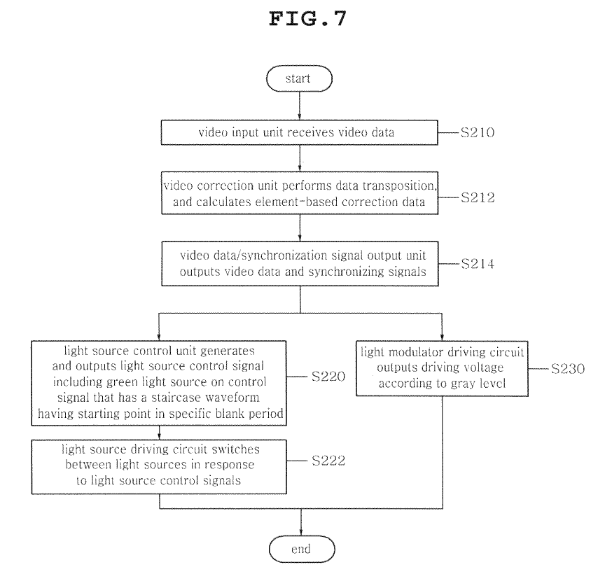

FIG. 5 is a diagram showing the construction of a device for controlling the output of a light source unit according to a preferred embodiment of the present invention. FIG. 6 is a flowchart of a method of controlling the output of a light source unit according to a first preferred embodiment of the present invention. FIG. 7 is a flowchart of a method of controlling the output of a light source unit according to a second preferred embodiment of the present invention.

Referring to FIG. 5, the device for controlling the output of a light source unit according to the preferred embodiment of the present invention includes a video input unit 202, a gamma reference voltage storage unit 204, a video correction unit 206, an element-based correction data storage unit 208, a video data/synchronization signal output unit 210, an upper electrode voltage range adjusting unit 212, a lower electrode voltage range adjusting unit 214, a light source control unit 216, a light modulator driving unit 218, and a light source driving unit 220.

The video input unit 202 receives video data, and, at the same time, receives a vertical synchronizing signal Vsync and a horizontal synchronizing signal Hsync.

The video correction unit 206 converts laterally input video data into vertically arranged video data by performing a data transposition (or video pivoting) process of converting laterally arranged video data into vertically arranged data, and outputs the vertically arranged data. The reason that the video correction unit 206 requires data transposition is that a scan line, emitted from the diffractive optical modulator 110, is configured such that it is scanned and displayed in a lateral direction because a plurality of diffracted light spots corresponding to a plurality of pixels (for example, 480 pixels in the case where the number of pieces of input video data is 480*640) is arranged in a vertical direction.

Meanwhile, the gamma reference voltage storage unit 204 stores upper electrode (gamma) reference voltages and lower electrode (gamma) reference voltages. Here, “upper electrode (gamma) reference voltages” means upper electrode reference voltages that are referenced when the optical modulator driving circuit 218 of the diffractive optical modulator 110 outputs application voltages for respective elements according to the gray levels of video data, and “lower electrode reference voltages” means voltages that are applied to the lower electrodes of the diffractive optical modulator 110.

The reason that the upper electrode reference voltages and the lower electrode reference voltages are stored in the gamma reference voltage storage unit 204 and are referenced by the optical modulator driving circuit 218 of the diffractive optical modulator 110 when the diffractive optical modulator 110 outputs application voltages according to gray levels is that the intensity of diffracted light, emitted from the diffractive optical modulator 153, exhibits a gamma characteristic in which it does not vary linearly with the level of applied voltage, but varies nonlinearly.

In this situation, when a gray level of video data is input from the video data/synchronization signal output unit 210, the optical modulator driving circuit 218 acquires an upper electrode voltage corresponding to the gray level with reference to the upper electrode reference voltage, provided through the upper electrode voltage range adjusting unit 212, so as to acquire an upper electrode voltage that matches the gray level. At this time, the upper electrode voltage range adjusting unit 212 reads the upper electrode reference voltage from a gamma reference voltage storage unit 204, and outputs the read upper electrode reference voltage to the optical modulator driving circuit 218. At the same time, a lower electrode voltage is provided to the diffractive optical modulator 214 by the lower electrode voltage adjusting unit 214. That is, the lower electrode voltage adjusting unit 214 reads the lower electrode reference voltage from the gamma reference voltage storage unit 204 and provides it to the lower electrode of the diffractive optical modulator 110.

Accordingly, the diffractive optical modulator 110 is driven based on the upper electrode voltage provided by the optical modulator driving circuit 218 and the lower electrode voltage provided by the lower electrode voltage adjusting unit 214, and generates diffracted light by modulating incident light.

Meanwhile, the element-based correction data stored in the element-based correction data calculation unit 208 is referenced to create corrected video data by correcting video data from the image correction unit 206, and may be arranged in a table.

The video data/synchronization signal output unit 210 provides video data, output from the video correction unit 206, to the optical modulator driving circuit 218.

The video data/synchronization signal output unit 210 receives a vertical synchronizing signal and a horizontal synchronizing signal from the video correction unit 206 and outputs them.

Meanwhile, when the vertical synchronizing signal and the horizontal synchronizing signal are received from the video data/synchronization signal output unit 210, the light source control unit 216 controls the light source driving circuit 220 in response to the vertical and horizontal synchronization signals so that the light source driving circuit 220 switches between the light sources.

Meanwhile, when video data (gray levels) is received from the video data/synchronization signal output unit 210, the optical modulator driving circuit 218 creates a corresponding driving voltage with reference to the upper electrode reference voltage provided by the upper electrode voltage range adjusting unit 212, and outputs the driving voltage to the diffractive optical modulator 110.

In this case, the video input unit 202, the video correction unit 206, and the element-based correction data storage unit 208 may be collectively referred to as a video processing unit that receives video data and synchronizing signals from the video data/synchronization signal output unit 210, performs data transposition, outputs red video data and blue video data in an effective video period, outputs green video data having gray level 0 in a blank period before the effective video period, outputs the received video data in the effective video period, and outputs the received synchronizing signals.

Furthermore, the light source control unit 216 and the light source driving circuit 220 may be collectively referred to as a light source driving unit that, when synchronizing signals are input from the video processing unit, applies driving voltage for the red light source and the blue light source in an effective video period and applies driving voltage for the green light source in a blank period before the effective video period with respect to green video data.

Now, with reference to FIGS. 5 to 9, the operation of a device for controlling the output of a light source unit according to a preferred embodiment of the present invention will be described in detail below.

### Embodiment 1

First, the video input unit 202 receives video data, and, at the same time, receives a vertical synchronizing signal Vsync and a horizontal synchronizing signal Hsync at step S110.

The video correction unit 206 converts laterally input video data into vertically arranged video data by performing data transposition (or video pivoting). The video correction unit 206 corrects the video data with reference to the element-based correction data stored in the element-based correction data storage unit 208, and outputs the corrected video data at step S112.

The video data/synchronization signal output unit 210 provides the video data, output from the video correction unit 206, to the light modulator driving circuit 218, and provides the synchronizing signals to both the light source control unit 216 and the light modulator driving circuit 218 at step S114.

In this case, the video data/synchronization signal output unit 210 provides video data, output from the video correction unit 206, to the light modulator driving circuit 218, particularly green video data having gray level 0 in a blank period that exists before green video data is provided.

Here, the term “blank period” refers to each of the time periods that exist between effective video time periods. In general, in order to realize a color image in a display device using a single reflective light modulator 110, it is necessary to sequentially scan red video data, green video data and blue video data across the screen 118 for a predetermined period of time. In this case, the period in which red video data is scanned across the screen 118 is referred to as an effective video period, the period in which green video data is scanned across the screen 118 is also referred to as an effective video period, and the period in which blue video data is scanned across the screen 118 is also referred to as an effective video period. Meanwhile, there is a gap between the scanning of the red video data and the scanning of the green video data, and this gap is referred to as a blank period. In the same way, there is a gap between the scanning of green video data and the scanning of blue video data, and this gap is referred to as a blank period. In the same way, there is a gap between the scanning of green video data and the scanning of red video data, and the gap is referred to as a blank period.

As described above, the display device using a single reflective light modulator 110 provides a plurality of effective video periods and blank periods. When the video data/synchronization signal output unit 210 provides the video data, output from the video correction unit 206, to the light modulator driving circuit 218, the video data/synchronization signal output unit 210 provides green video data having gray level 0 in a blank period (a blank period that exists at the time of switching from red video data to green video data) that exists before green video data is provided.

Meanwhile, when the synchronizing signals are input from the video data/synchronization signal output unit 210, the light source control unit 216 controls the light source driving circuit 220 in response to the synchronization signals at step S120 so that the light source driving circuit 220 switches between the plurality of light sources at step S122.

In this case, when the synchronizing signals are input from the video data/synchronization signal output unit 210, the light source control unit 216, for the red light source and the blue light source, generates light source-on control signals in conjunction with the synchronizing signals and provides the control signals to the light source driving circuit 220, while the light source control unit 216, for the green light source, generates a light source-on control signal in a blank period before the input of the synchronizing signals and provides the control signal to the light source driving circuit 220.

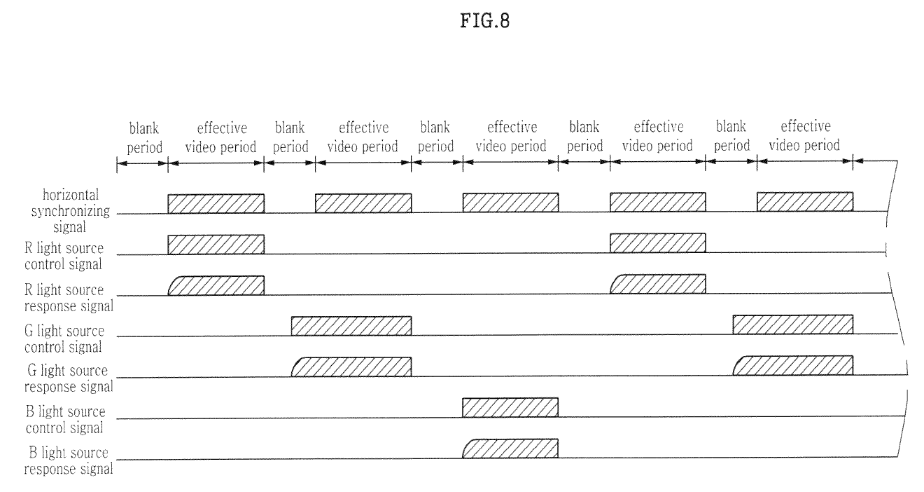

That is, referring to FIG. 8, the light source control unit 216 receives synchronizing signals indicative of an effective video period from the video data/synchronization signal output unit 210.

Then, the light source control unit 216 sequentially generates a red light source-on control signal, a green light source-on control signal and a blue light source-on control signal in conjunction with the synchronizing signals from the video data/synchronization signal output unit 210, and provides them to the light source driving circuit 220.

In this case, the light source control unit 216 generates a red light source-on control signal in conjunction with the synchronizing signals indicative of an effective video period, and outputs the control signal to the light source driving circuit 220. Then, the light source driving circuit 220 turns on the red light source in response to the red light source-on control signal from the light source control unit 216, with the result that the red light source is turned on, and thus red light is emitted in the effective video period, as shown in FIG. 8.

Furthermore, in a blank period after the generation and emission of the red light source-on control signal in the effective video period and before the input of synchronizing signals indicative of a subsequent effective video period, the light source control unit 216 generates a green light source-on control signal and then outputs the control signal to the light source driving circuit 220.

Then, when a green light source-on control signal is received from the light source control unit 216, the light source driving circuit 220 turns on the green light source.

If so, the green light source is turned on in a blank period and then emits green light, in which case some time is taken to emit light having a desired light intensity because the green light source is a solid light source. That is, the green light source is turned on in a blank period, the output thereof gradually increases, and light having a desired light intensity is emitted in an effective video period. However, since the green light source emits light before the effective video period, a garbage image may be created on the screen 118. To solve this problem, the video data/synchronization signal output unit 210 outputs green video data having gray level 0 in the blank period, as described above.

As described above, after generating the green light source-on control signal, the light source control unit 216 generates a blue light source-on control signal in conjunction with synchronizing signals indicative of an effective video period and outputs the control signal to the light source driving circuit 220. Then, the light source driving circuit 220 turns on the blue light source in response to the blue light source-on control signal from the light source control unit 216, with the result that the blue light source is turned on, and thus blue light is emitted in the effective video period, as shown in FIG. 8.

Meanwhile, when video data (a gray level) is input from the video data/synchronization signal output unit 210, the light modulator driving circuit 218 generates driving voltage and outputs the driving voltage to the reflective light modulator 110 at step S130. In this case, since the light modulator driving circuit 218 receives green video data having gray level 0 from the video data/synchronization signal output unit 210 in a blank period (a blank period during switching from red video data to green video data) existing before the provision of green video data, as described above, the reflective light modulator 110 generates driving voltage capable of generating video data having gray level 0 and provides the driving voltage to the reflective light modulator 110, with the result that the reflective light modulator 110 generates video data having gray level 0 in the blank period. Accordingly, since the video data having gray level 0 is emitted from the reflective light modulator 110 and is scanned across the screen 118, a garbage image formed by light emitted from the green light source in the blank period is not created on the screen 118.

### Embodiment 2

First, the video input unit 202 receives video data, and, at the same time, receives a vertical synchronizing signal Vsync and a horizontal synchronizing signal Hsync at step S210.

The video correction unit 206 converts laterally input video data into vertically arranged video data by performing data transposition (or video pivoting). The video correction unit 206 corrects the video data with reference to the element-based correction data stored in the element-based correction data storage unit 208, and outputs the corrected video data at step S212.

The video data/synchronization signal output unit 210 provides the video data, output from the video correction unit 206, to the light modulator driving circuit 218, and provides the synchronizing signals to both the light source control unit 216 and the light modulator driving circuit 218 at step S214.

Meanwhile, when the synchronizing signals are input from the video data/synchronization signal output unit 210, the light source control unit 216 controls the light source driving circuit 220 in response to the synchronization signals at step S120, whereby the light source driving circuit 220 switches between the plurality of light sources at step S222.

In this case, when the synchronizing signals are input from the video data/synchronization signal output unit 210, the light source control unit 216 for the red light source and the blue light source generates light source-on control signals in conjunction with the synchronizing signals and provides the control signals to the light source driving circuit 220, while the light source control unit 216 for the green light source generates a light source-on control signal having a staircase waveform in a blank period before the input of the synchronizing signals, and provides the control signal to the light source driving circuit 220.

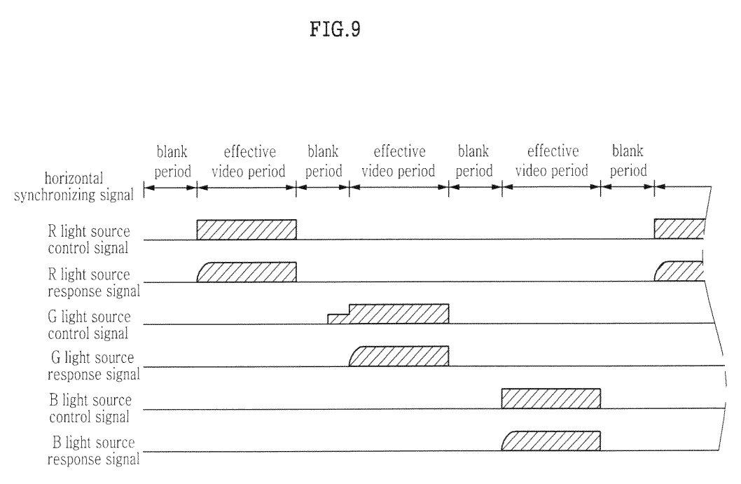

That is, referring to FIG. 9, the light source control unit 216 receives synchronizing signals, indicative of an effective video period, from the video data/synchronization signal output unit 210.

Then, the light source control unit 216 sequentially generates a red light source-on control signal, a green light source-on control signal and a blue light source-on control signal in conjunction with the synchronizing signals from the video data/synchronization signal output unit 210, and provides them to the light source driving circuit 220.

In this case, the light source control unit 216 generates a red light source-on control signal in conjunction with the synchronizing signals indicative of an effective video period, and outputs the control signal to the light source driving circuit 220. Then, the light source driving circuit 220 turns on the red light source in response to the red light source-on control signal from the light source control unit 216, with the result that the red light source is turned on, and thus red light is emitted in the effective video period, as shown in FIG. 8.

Furthermore, in a blank period after the generation and emission of the red light source-on control signal in the effective video period and before the input of synchronizing signals indicative of a subsequent effective video period, the light source control unit 216 generates a green light source-on control signal having a staircase waveform and then outputs the control signal to the light source driving circuit 220.

Then, when the green light source-on control signal is input from the light source control unit 216, the light source driving circuit 220 turns on the green light source using a light source-on driving signal having the same staircase waveform. Here, the green light source-on control signal, generated by the light source control unit 216, has a staircase waveform, and voltage, indicated by the first step of the staircase waveform, is adjusted such that it is sufficient to excite the green light source, but is insufficient to fully activate the green light source. By doing so, the light source driving circuit 220 may be configured to provide driving voltage to the green light source, but not to emit light before an effective video period because the red light source is not fully activated. As a result, a rapid response can be obtained from the green light source, and a garbage image is not created on the screen 118 because the height of the first step of the driving voltage generated by the light source driving circuit 220 is low, and thus light is not emitted from the red light source.

As described above, after generating the green light source-on control signal, the light source control unit 216 generates a blue light source-on control signal in conjunction with synchronizing signals indicative of an effective video period and outputs the control signal to the light source driving circuit 220. Then, the light source driving circuit 220 turns on the blue light source in response to the blue light source-on control signal from the light source control unit 216, with the result that the blue light source is turned on, and thus blue light is emitted in the effective video period, as shown in FIG. 9.

Meanwhile, when video data (gray levels) is input from the video data/synchronization signal output unit 210, the light modulator driving circuit 218 generates driving voltage and outputs the driving voltage to the reflective light modulator 110 at step S230.

As described above, the present invention has an advantage of solving the problem of the non-uniformity of light attributable to the slow response speed of a solid laser light source.

That is, the solid laser light source is used as the green light source. The solid laser light source has response speed characteristics inferior to those of a semiconductor laser because the light output characteristics are based on the internal pumping mechanism of the solid laser light source. Accordingly, when such a solid laser light source is employed in a display system that uses a single panel reflective light modulator, the problem of non-uniformity may occur along the scanning direction. The present invention has an advantage in that uniform light can be acquired at a desired time by turning on a solid laser light source in advance in a blank period.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A device for controlling output of a light source unit in a single panel display system using a diffractive light modulator, comprising:
a video processing unit for receiving video data and synchronizing signals, performing data transposition, outputting red video data and blue video data in an effective video period, outputting green video data having gray level 0 in a blank period before the effective video period with respect to green video data, outputting the received video data in the effective video period, and outputting the received synchronizing signals;
a light source driving unit for, when the synchronizing signals are input from the video processing unit, applying driving voltage to the red light source and the blue light source in the effective video period, and applying driving voltage to the green light source in the blank period before the effective video period, with respect to the green video data; and
a light modulator driving circuit for applying driving voltage to the reflective light modulator based on the video data from the video processing unit.

2. The device as set forth in claim 1, wherein the video processing unit comprises:
a video input unit for receiving the video data and the synchronizing signals;
a video correction unit for performing a data transposition process of converting the video data, received by and laterally input to the video input unit, into vertically arranged video data, and outputting the data-transposed video data; and
a video data/synchronization signal output unit for receiving the data-transposed video data and the synchronizing signals from the video correction unit, outputting the red video data and the blue video data in the effective video period, outputting, with regard to the green video data, the green video data having gray level 0 in the blank period before the effective video period and the received video data in the effective video period, and outputting the received synchronizing signals.

3. The device as set forth in claim 1, wherein the light source driving unit comprises:
a light source control unit for, when the synchronizing signals are input from the video processing unit, outputting on control signals to the red light source and the blue light source in the effective video period, and outputting an on control signal to the green light source in the blank period before the effective video period, with respect to the green video data; and
a light source driving circuit for switching between the light sources in response to the light source control signals of the light source control unit.

4. The device as set forth in claim 2, wherein the light source driving unit comprises:
a light source control unit for, when the synchronizing signals are input from the video data/synchronization signal output unit, outputting on control signals to the red light source and the blue light source in the effective video period, and outputting an on control signal to the green light source in the blank period before the effective video period, with respect to green video data; and
a light source driving circuit for switching between the light sources in response to the light source control signals of the light source control unit.

5. A device for controlling output of a light source unit in a single panel display system using a diffractive light modulator, comprising:
a video processing unit for receiving video data and synchronizing signals, performing data transposition, outputting data-transposed video data, and outputting the received synchronizing signals;
a light source driving unit for, when the synchronizing signals are input from the video processing unit, applying driving voltage to the red light source and the blue light source in the effective video period, and applying excitation driving voltage to the green light source in a blank period before the effective video period and driving voltage to the green light source in the effective video period, with respect to the green video data; and
a light modulator driving circuit for applying driving voltage to the reflective light modulator based on the video data from the video processing unit.

6. The device as set forth in claim 5, wherein the video processing unit comprises:
a video input unit for receiving the video data and the synchronizing signals;
a video correction unit for performing a data transposition process of converting the video data, received by and laterally input to the video input unit, into vertically arranged video data, and outputting the data-transposed video data; and
a video data/synchronization signal output unit for receiving the data-transposed video data and the synchronizing signals from the video correction unit, and outputting the data-transposed video data and the synchronizing signals.

7. The device as set forth in claim 5, wherein the light source driving unit comprises:
a light source control unit for, when the synchronizing signals are input from the video processing unit, outputting on control signals to the red light source and the blue light source in the effective video period, and outputting an excitation on control signal, capable of performing control so that excitation driving voltage can be provided to the diffractive light modulator, to the green light source in the blank period before the effective video period and an on control signal to the green light source in the effective video period, with respect to the green video data; and
a light source driving circuit for switching between the light sources in response to the light source control signals of the light source control unit.

8. The device as set forth in claim 6, wherein the light source driving unit comprises:
a light source control unit for, when the synchronizing signals are input from the video data/synchronization signal output unit, outputting on control signals to the red light source and the blue light source in the effective video period, and outputting an excitation on control signal, capable of performing control so that excitation driving voltage can be provided to the diffractive light modulator, to the green light source in the blank period before the effective video period and an on control signal to the green light source in the effective video period, with respect to the green video data; and
a light source driving circuit for switching between the light sources in response to the light source control signals of the light source control unit.
